(19) United States
(12) Patent Application Publication
(10) Pub. No.: US 2022/0002190 A1
(43) Pub. Date: Jan. 6, 2022

(54) FUNCTIONALIZED HOLLOW GLASS MICROSPHERES FOR RECOVERING FINE HYDROPHOBIC PARTICLES; METHOD FOR PREPARING THE MICROSPHERES; SYSTEM FOR CARRYING OUT THE METHOD; METHOD FOR RECOVERING FINE PARTICLES; AND USE OF THE MICROSPHERES

(71) Applicant: UNIVERSIDAD TÉCNICA FEDERICO SANTA MARÍA, Valparaíso (CL)

(72) Inventors: Sebastián Ignacio ARRIAGADA GALLEGOS, Valparaíso (CL); Matías Bernabé CONTRERAS URIBE, Valparaíso (CL); Claudio Abraham ACUÑA PÉREZ, Viña del Mar (CL)

(21) Appl. No.: 17/286,769

(22) PCT Filed: Oct. 19, 2018
(86) PCT No.: PCT/CL2018/050101

§ 371 Date: Apr. 19, 2021

(51) Int. Cl. C03C 11/00; C03C 23/00; B03D 1/002

(52) U.S. Cl. CPC C03C 11/002; C03C 23/00; B03D 2203/02; B03D 2201/02; B03D 1/002

(57) ABSTRACT

The present invention relates to functionalized hollow glass microspheres for recovering fine hydrophobic particles, and to their preparation method. The invention also relates to a system for carrying out the method for preparing the functionalized microspheres, to a method for selectively recovering fine material and, lastly, to the use of the microspheres in the separation of, inter alia, minerals, micro drops of organic materials, plastics, and pollutants.

### FIELD OF APPLICATION

The present invention refers to the recovery of fine particles, more particularly to a system and method for the separation, recovery and/or concentration of hydrophobic elements, such as minerals (copper, gold, molybdenum, carbon, platinum, rare earths, among others), microdroplets of organic compounds, solvents, plastics, bitumen, pollutants, among others; by using functionalized hollow glass microspheres (functionalized glass bubbles).

### DESCRIPTION OF PRIOR ART

Separation processes, in particular liquid-liquid and solid-liquid separations, allow compounds of interest to be recovered from the medium that contains them. However, there are particles that, to date, are not efficiently recovered due to their fine size, given their low inertia or the lack of separation means.

For example, in solvent extraction (SX), microdroplets of organic compounds are generated produced by the drag to the aqueous phase, which cannot be collected since the size of the drops does not allow it. This generates loss of reagents and slows down the increase in the efficiency of the process. A similar scenario occurs in the case of iodine since there are losses of organic molecules due to this same fact. This condition extends to all solvent extraction processes: lithium, cesium, rubidium, uranium, nickel, rhenium, rare earths, niobium, germanium, indium, among others.

Another case is flotation, which is a physicochemical process that consists of three phases, solid-liquid-gaseous, and whose objective is the separation of mineral species from a pulp or suspension through the selective adhesion of hydrophobic particles (water repellent) to air bubbles.

The basic principles on which the flotation process is based are the following:
The hydrophobicity of the mineral (natural or chemically modified, for example, through the use of collectors), which allows the adherence of solid particles to the surface of air bubbles (naturally hydrophobic), given the minimization of surface energies.
The transport of the particle-bubble aggregate, united by surface forces, from the collection zone to the froth zone.
The formation of a stable froth on the surface of the water, which allows the particles to be maintained over time and subsequently to recover the valuable material in the form of a concentrate (10 to 30 times the concentration of the head grade).

Hydrophobic mineral particles have the ability to adhere to the bubble, while hydrophilic ones, such as gangue, do not adhere. The hydrophobic surface exhibits affinity for the gaseous phase and repels the liquid phase, while the hydrophilic surface has affinity for the liquid phase. This feature allows the selective separation of valuable materials, where efficiency depends on particle sizes.

The recovery of the valuable species depends on the quantity and size of the particles present in the pulp. Additionally, the stability and size of the air bubbles that transport said particles directly influence their recovery.

In a process in which many small bubbles (0.5 to 2 mm) are produced, a greater recovery will be obtained compared to that obtained with larger bubbles and in smaller quantities, since said recovery depends on the surface area of the bubbles available for particles to adhere to them. In the case of particles, these are efficiently recovered only if they are in an appropriate size range (over 20 and under 200 microns).

In the mineral flotation process, hydrophobic particles are collected by a bubble swarm. The particles are collected by the bubbles because the adhesion of a hydrophobic particle (which is originally suspended in water) to the surface of an air bubble is a thermodynamically favorable phenomenon. However, the collection efficiency depends on the probability of collision and adhesion between bubbles and particles, which in both cases are dependent on the relative sizes of particle and bubble. Fine particles, smaller than 20 microns, are not collected under any combination of bubble size. The main reason for the inefficiency of fine particles flotation is that the probability of collision between the particles and the gas bubbles decreases as the particle size decreases. The low probability of collision is due to hydraulic drags or flow lines generated by the bubbles rising in the pulp: In this medium, fine particles that have a low mass (and therefore low inertia) are deflected by the turbulence generated by the bubbles ascending. Rather, the primary fine particles recovery mechanism is drag (entrainment), that is, the transport of particles dragged by water in the froth; which is a non-selective mechanism. In practice, the above problem implies that mineral processing plants have losses in the recovery of valuable material due to inefficiency in the collection of said material.

Another similar problem occurs when microdroplets of organic components are present in water. When two immiscible liquids come together, and one of them disperses in another forming drops, it is said to be an emulsion. The problem results in that, when there is an emulsion of microdroplets, said emulsion is extremely stable, which complicates its separation. Organic microdroplet emulsions present hydraulic dragging problems similar to those observed in the flotation process.

For purposes of this description, fine material is understood to be any substance characterized by having a size small enough to cause its recovery to be non-selective, or that its recovery efficiency is significantly lower than that obtained when the size is within the normal operating range of a certain process. In the case of mineral flotation, fine materials are understood to be equal to or below 20 microns.

Several alternatives have been proposed to solve the problem of loss of fine material. Among them, for example, is the DAF (“Dissolved Air Flotation”) technology, which consists of dissolving air in pressurized water, and then generating air microbubbles in a flotation cell resulting from expansion. However, this technology does not demonstrate significant differences in the selective recovery of fine material, and is limited by the low amount of air that can dissolve in water even at high pressures. Furthermore, the recovery of fine material with air microbubbles has been proposed, so that the selective transport is improved by generating a mixture of microbubbles (10-100 microns) compared to dispersed bubbles (1,000 microns). By doing so, a precipitation of fine particles between 1 to 20 microns would be generated to later be collected. The problem with this technique is that little mass can be transported to the concentrate, and also the use of microbubbles induces entrainment, which is not operationally efficient. In summary, to date, it has not been possible to generate or establish a clear model that relates the variables that determine the flotation of fine particles, much less a technology that allows a selective separation of the fine particles.

In a different context, conventional hollow glass microspheres have been known for many years and various methods and apparatus have been proposed for their production, as presented in the patents of Franklin Veatch et al U.S. Pat. Nos. 2,978,340, 3,030,215, 3,129,086, and 3,230,064.

Conventional hollow glass microspheres have been used for various applications, with great success as fillers for composites and polymer additives to reduce weight, noise, vibration, and thermal expansion.

The present invention proposes to use said hollow glass microspheres as a base structure, and applying a chemical reaction on the surface of the glass to allow the adherence of a compound of an organic nature to said surface. The organic nature of the compound is what gives the hydrophobicity to the surface of the hollow glass microspheres, generating a product of very small size and highly hydrophobic, i.e., water repellent. The above properties allow functionalized hollow glass microspheres to recover and concentrate hydrophobic elements such as minerals, organic microdroplets, plastics, pollutants, among others.

Patent document AU 2012258597 describes a synthetic bead having a surface made of, or coated with, a synthetic material, such as a polymer that is naturally hydrophobic or a polymer that is hydrophobically modified. This bead can be made of glass having a coating comprising a siloxane. The synthetic beads can be placed in a flotation cell containing a mixture of water, collector molecules, valuable material and unwanted material or in a pipeline where the mixture is transported from one location to another. The collector chemical can be xanthates. The enriched synthetic beads carrying the mineral particles are separated from the unwanted materials in the mixture. The mineral particles are then released from the synthetic beads by means of low pH treatment, ultrasonic agitation, thermal or electromagnetic treatment.

However, the above patent document does not use functionalized hollow glass microspheres, but rather describes an invention of solid spheres, bubbles, or beads, which can be made of glass or metal. Furthermore, patent document AU 2012258597 discloses that the beads are coated with synthetic silicone polymers, which can be hydrophobic by nature or can be functionalized on their surface to make them hydrophobic. In other words, this document does not detail a direct functionalization (i.e., chemical bond) on the surface of the glass, but rather describes a process in which the glass is coated with a polymer and said polymer is eventually functionalized in the case it does not present natural hydrophilicity. The foregoing is at variance with the present invention, which proposes the use of hollow glass microspheres that are not covered by any synthetic polymer. Rather, the microspheres of the present invention are functionalized directly on the glass surface to make them hydrophobic, through a chemical reaction carried out in the liquid phase, using a reaction system that will be described later and developed by the inventors of the present invention.

Patent document KR 101685291 describes a super-water-repellent glass bead using chemical treatment, and to a manufacturing method thereof. However, this document does not reveal further details on separation efficiency, and on the other hand refers to solid beads of conventional size, which are not usable in flotation given their density of 2.6 g/ml, that is, this material does not float, but decants, unlike a hollow microsphere with a density of 0.37 g/ml, which has natural buoyancy.

Patent application document CN 103740138 describes a hollow glass bead surface hydrophobic processing method comprising the following steps: a) dissolving a silane coupling agent into water according to a mass ratio of 1 to 5%, wherein the silane coupling agent is fully hydrated and forms a modified solution, storing the modified solution in a stainless steel container; b) pouring hollow glass beads into the stainless steel container, fully stirring so as to ensure that all surfaces of the hollow glass beads are evenly coated by the hydrated silane coupling agent; c) fishing out the hollow glass beads, and drying the hollow glass beads in an oven at a temperature of 150° C. so as to obtain the modified hollow glass beads.

However, this patent document, despite using hollow glass beads, details the use of an inorganic molecule SiH₄ (silane, silicon hydride), which adds hydrogens to the surface of the glass (SiO₂), generating a hydrophilic surface. In contrast, the present invention uses organic molecules (alcohols or organic compounds with hydroxyl groups), which through functionalization (chemical reaction) are chemically adhered to the surface of the glass, which improves the control of hydrophobicity.

### SUMMARY OF THE INVENTION

The present invention provides functionalized hollow glass microspheres produced through a transformation method where organic molecules chemically react on their surface. The method consists of an esterification reaction between the silanol group (Si—O—H) on the surface of the glass and the hydroxyl group (—OH) of an alcohol, selected from the group consisting of ethanol, butanol, octanol, dodecanol, or other primary or secondary alcohol of similar characteristics; as well as other linear or branched organic molecules compatible with the methodology.

The transformation process is carried out in a container at the boiling temperature of the organic molecule that is used to functionalize the surface of the glass, through a system of reaction and reuse of alcohol.

As a result, a new material is generated with the following properties: size distribution of the hollow microspheres covers from 1 to 300 microns, density between 0.1 to 0.75 g/ml, and a wall surface that resists up to 30,000 psig.

The use of the functionalized hollow glass microspheres is carried out through a new process that consists of the following circuit: contactor equipment, separation equipment, and finally a recovery equipment for the functionalized hollow glass microspheres. The circuit described above is included in a process for recovering some hydrophobic element of interest, either in an intermediate stage of said process or as a final recovery stage.

The applications of functionalized hollow glass microspheres are varied, among which are the recovery of tails in a flotation cleaner circuit, the hydrocyclone overflow in a tailings treatment plant, organic compounds dragged in a solvent extraction plant, oil microdroplets in chemical industries, wastewater with dispersions of small organic elements, among others.

### BRIEF DESCRIPTION OF THE FIGURES

FIG. 1: Diagram of the preparation method of the functionalized hollow glass microspheres.

FIG. 2: General diagram of the method for selectively recovering fine material using functionalized hollow glass microspheres.

FIG. 3: Photographs comparing the collection of hydrophobic material without microspheres (left), with non-functionalized glass microspheres (center), and with functionalized glass microspheres according to the present invention (right).

FIG. 4: Microscopic photograph of the collection of functionalized hollow glass spheres.

FIG. 5: Comparative graph of the flotation kinetics (recovery versus time) of the process without microspheres (A), with conventional microspheres (B), and functionalized microspheres according to the present invention (C).

FIG. 6: Comparative graph of the grade-recovery curve of the process without microspheres (A), with conventional microspheres (B), and functionalized microspheres according to the present invention (C).

FIG. 7: Graphic representations of the flow lines generated by the rise of bubbles in a liquid medium (A), the deflection of fine particles by the flow lines and their consequent loss when trying to recover them by means of bubbles (B), the adhesion of fine particles to functionalized microspheres (C), and recovery of fine particles adhered to functionalized microspheres by means of a bubble (D).

### DETAILED DESCRIPTION OF THE INVENTION

The present invention relates to a method for the functionalization (also known as hydrophobization) of hollow glass microspheres by the chemical adhesion of organic molecules to their surface. This method considers the preparation of the raw materials, the operating conditions of the chemical reaction, the separation process of the final product, the possible chemical agents to be used, among others.

This invention also relates to the design of the laboratory scale, pilot scale, and/or industrial scale process for the production of functionalized hollow glass microspheres from existing commercial hollow glass microspheres.

This invention also relates to the use of functionalized hollow glass microspheres in a flotation circuit, with the objective of increasing the selective recovery of fine particles. In the same way, this invention relates to a method for the selective recovery of fine particles in industrial flotation circuits and/or to the modification of existing flotation circuits for the use of functionalized hollow glass microspheres.

Additionally, the present invention is also applicable to the selective recovery of dragged organic compounds in solvent extraction plants, iodine recovery, oil microdroplets recovery in chemical industries, wastewater with dispersions of small organic elements, and the like.

According to the present invention, the functionalization (or hydrophobization) reaction of the surface of hollow glass microspheres is described. The hydrophobization of glass consists of reacting the silanol group present on the surface of the glass and an organic compound with a hydroxyl group (OH). For example, in the case of primary or secondary alcohols, functionalization is described by the following chemical reaction:

Si—O—H+O—H—CₓH_{y}↔Si—O—CₓH_{y}+H₂O

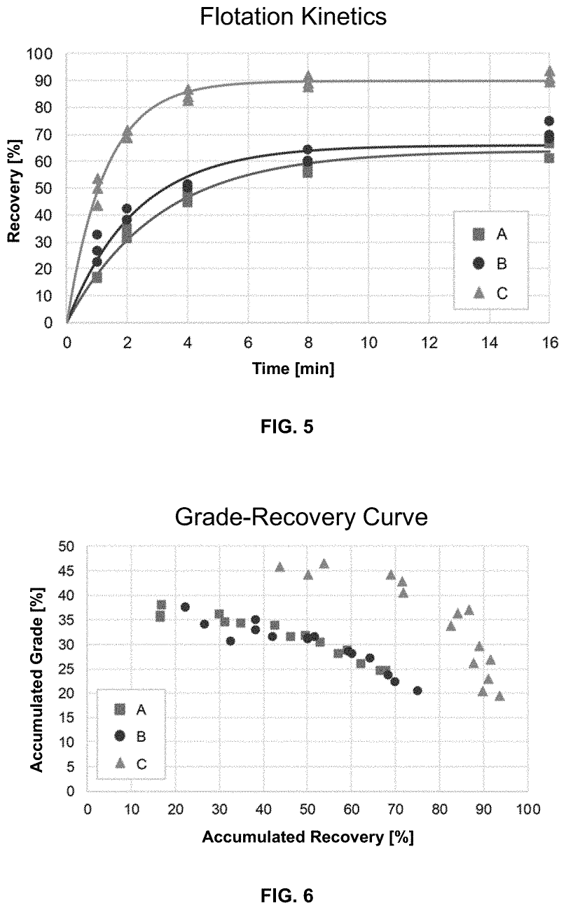

Multiple chemical compounds can be used for the functionalization of glass microspheres, such as alcohols, collectors, among others. In this way, the present invention transforms an already known product, such as hollow glass microspheres that are not capable of collecting fine hydrophobic material by themselves, into a modified product that is capable of selectively recovering fine hydrophobic material, by means of chemical reactions (see FIG. 5 and FIG. 6).

Ordinary hollow glass microspheres have properties that are necessary for the recovery of fine material. Regarding the above, one of the most important, among these, is the particle size of the hollow glass microspheres. It has already been mentioned that the problem in the recovery of fine material is due to the hydraulic dragging suffered by said small mass material produced by large bubbles. Since hollow glass microspheres have small sizes from 1 to 300 microns, similar to that of the fine material to be recovered, the probability of their collision increases considerably, which is quantifiable through the Stokes dimensionless number parameter. However, glass is hydrophilic in nature, which prevents ordinary hollow glass microspheres from collecting hydrophobic particles, regardless of whether they are able to effectively collide with the particles. For this reason, hollow glass microspheres require a mechanism to change their surface properties. The previously described chemical reaction allows the surface of hollow glass microspheres to be hydrophobicized, allowing it to collect hydrophobic material, thus transforming into a new product that has a different nature than ordinary hollow glass microspheres. In summary, the combination of physical properties of ordinary hollow glass microspheres (such as size) and the change in their nature from a hydrophilic behavior to a hydrophobic one through chemical reactions, allow to obtain a new material such as functionalized hollow glass microspheres, which meet two fundamental requirements in flotation: effective collision and selective adhesion of hydrophobic particles.

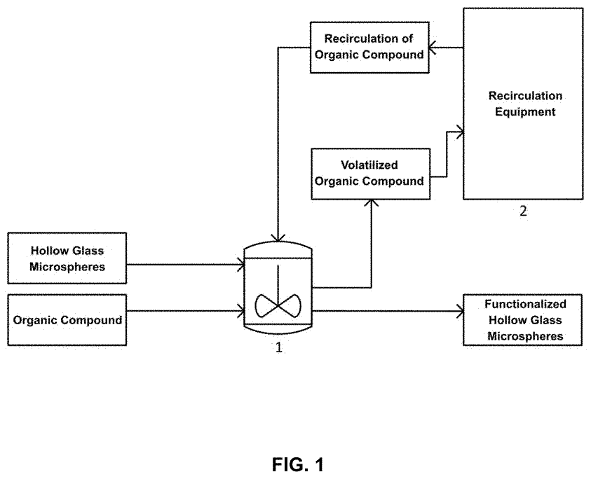

According to the present invention and FIG. 1, the method for the functionalization of glass microspheres comprises, firstly, introducing the conventional hollow glass microspheres to a reactor (1) together with the chemical compound that is used to carry out functionalization. The reactor (1) used can be of the batch or continuous type. The reactor (1) can be operated at atmospheric pressure or at a pressure other than atmospheric. The organic compound must be in the liquid phase.

Subsequently, the mixture between hollow glass microspheres and the chemical compound is heated inside the reactor (1) to the boiling point. At this point, part of the liquid changes into the gaseous state. Said gas can be returned to the liquid phase by means of a recirculation equipment (2) and then it can be reincorporated to the reactor (1); or the gas can be removed from the reactor (1), while feeding fresh liquid from another source. The reaction time depends on the boiling temperature of the system: the higher the temperature, the shorter the time required for the reaction. The reaction temperature can be modified by the pressure of the reactor (1): a reactor at a higher pressure involves a higher boiling temperature.

Once the reaction is finished, the functionalized hollow glass microspheres immersed in the remaining solution are removed from the reactor (1). The solid can be separated from the liquid by filtration. For example, when performing the procedure in the laboratory, separation of the functionalized hollow glass microspheres can be accomplished by vacuum filtration using filter paper, a Buchner funnel, Kitasato flask, and a vacuum pump. Optionally, the functionalized hollow glass microspheres can be washed after filtration with water, acetone, and ethyl alcohol to remove acetone.

Finally, the functionalized hollow glass microspheres can be stored dry or wet. In the first case, they need to be dried in a suitable equipment, be it an oven, a rotary dryer, drying by pneumatic transport or a pertinent drying technology. In case of being stored wet, they must be mixed with water. Wet storage allows to extend the useful life of the product.

After the previous process, the final product called functionalized hollow glass microspheres is obtained, which have the following main properties:

TABLE 1
Properties of functionalized hollow glass microspheres.

| | |
|---|---|
| Composition | Hollow glass microspheres made from glass, coated |
| | by an organic substance that adheres to the glass |
| | surface through a chemical bond. |
| Density | 0.1-0.75 [g/ml] |
| Isostatic Crush | Up to 30,000 [psi] |
| Pressure | |
| Particle size | Size distribution between 1 to 300 [microns] |

The degree of hydrophobicity reached on the glass surface depends on the organic substance used in the functionalization reaction. The contact angle is a measure of the degree of hydrophobicity: the greater the contact angle, the more hydrophobic the surface. As an example, Table 2 shows the contact angle values for glass functionalization with 3 different reagents: butanol, octanol, and dodecanol.

TABLE 2
Contact angle of the functionalized
glass surface with various alcohols.

| | Advanced | Receding | Average |
|---|---|---|---|
| | Contact Angle | Contact Angle | Contact Angle |
| Alcohol | (°) | (°) | (°) |
| 1-Butanol | 58 | 39.5 | 48.75 |
| 1-Octanol | 73.5 | 67.5 | 70.5 |
| 1-Dodecanol | 84 | 74.5 | 79.25 |

Glass microsphere functionalization can be performed on a pilot scale, laboratory scale, or industrial scale. In all cases, a system is required whose configuration has, at least, the unit operations represented in FIG. 1:
Reactor (1): where the necessary conditions are provided for the functionalization chemical reaction to occur. Said reactor (1) can be batch type or continuous type. To reach the boiling temperature of the liquid phase, the reactor (1) must be heated by some mechanism, be it a heating plate (especially useful for laboratory-scale production), heating jacket, heating coil, tube bundle heated by steam or other, radiation, microwaves, or any other technology. Furthermore, the reactor (1) is required to have sufficient stirring to keep the hollow glass microspheres in suspension and constantly mixed. This can be achieved, for example, by means of a magnetic stirrer, mechanical stirrer, the turbulence of the flow itself, etc.
Recirculation equipment (2): for vapors generated resulting from boiling within the reactor (1). A direct replacement of the evaporated organic compound product of said boiling can be made. There are the following alternatives:
   Recirculation equipment (2): It can be a condenser that returns the generated vapors to a liquid state. Then, this condensate is recirculated towards the reactor (1).
   Recirculation equipment (2): It can be equipment that allows the separation of the water generated by the reaction of the organic compound, for example, a distillation column, an absorption tower, etc. Once separated, the organic compound can be recirculated back to the reactor (1).
   Recirculation equipment (2): It can be a desiccant (for example, based on CaH₂) that allows extracting the generated water and purifying the evaporated alcohol.
   Fresh feed of organic compound.

The recirculation equipment (2) of the organic compound can be comprised of any of the alternatives described above, either separately or any combination thereof, for example, only one distillation column or only one absorption tower, or a combination between a distillation column and an absorption tower.

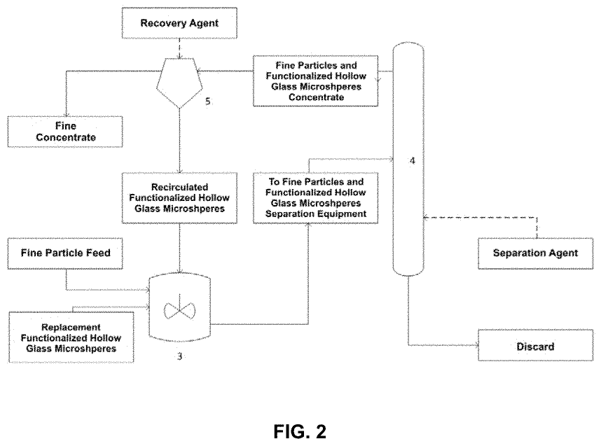

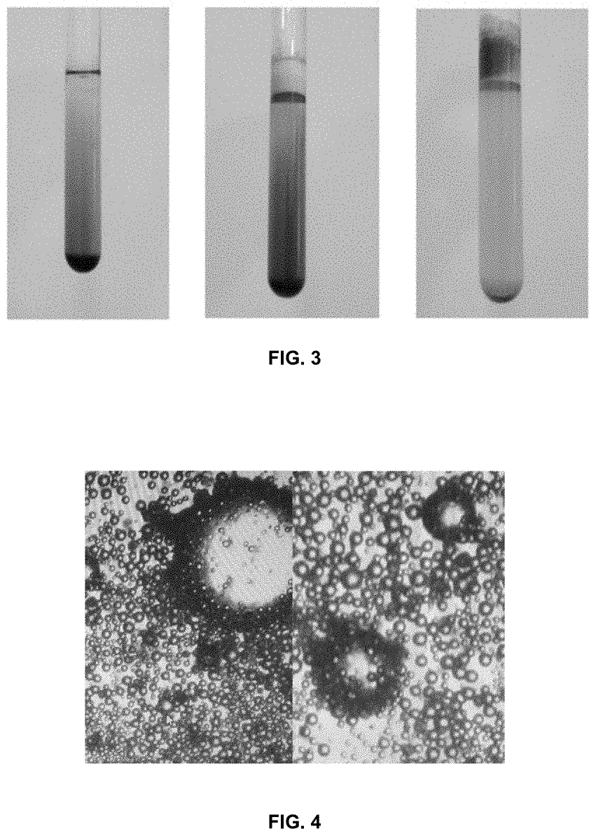

An industrial application of functionalized hollow glass microspheres in a method to enhance the selective recovery of fine material is shown in FIG. 2. The method consists of feeding functionalized hollow glass microspheres (represented as the replacement stream of glass microspheres of FIG. 2) and fine material to a contactor equipment (3). The material can be suspended as particles in a liquid in case they are solid; or as microdroplets forming emulsions in case they are liquid. In the case of being microdroplets, the feed corresponds to an emulsion. In the contactor equipment (3) the necessary conditions are provided so that the functionalized hollow glass microspheres can collide with the fine material, thus achieving their adhesion. Thanks to the effect of the contactor equipment (3), a stream of functionalized hollow glass microspheres with adhered fine material is obtained, which is sent to a separation equipment (4).

In the separation equipment (4), the necessary conditions are generated for the functionalized hollow glass microspheres with adhered fine material to be effectively separated from the medium in which they are immersed. This separation equipment could operate by physical principles of separation (such as gravity for the separation of immiscible compounds in water), or it could require a separation agent (as in the case of flotation, where the separation agent is air). Two streams are generated as a result of the action of the separation equipment (4):
First, a stream enriched in functionalized hollow glass microspheres with adhered fine material, represented by the stream that exits from the top of the separation equipment (4) in FIG. 2.
Second, a discard stream that corresponds to a stream from which all or a large part of the fine material of interest that initially contained the feed to the contactor equipment (3) has been removed. The discard stream is represented by the stream that exits from the bottom of the separation equipment (4) in FIG. 2.

The fine material recovery process by using functionalized hollow glass microspheres can end with the fine material concentrate obtained from the separation equipment (4). Optionally, a functionalized hollow glass microsphere recovery equipment (5) may be considered, as shown in FIG. 2. This option allows recycling the functionalized hollow glass microspheres, thus reducing the consumption of functionalized hollow glass microspheres fed to the contactor equipment (3).

In case of implementing the above, the functionalized hollow glass microsphere concentrate with adhered fine material is fed to the functionalized hollow glass microsphere recovery equipment (5). In the functionalized hollow glass microsphere recovery equipment (5), the necessary conditions are generated to promote the separation between the functionalized hollow glass microspheres and the fine material adhered to them. Said separation can be by physical methods or it may require the incorporation of a separation agent, which corresponds to a substance or material that allows the abovementioned separation. Two streams are obtained from the functionalized hollow glass microsphere recovery equipment (5):
1. A stream of functionalized hollow glass microspheres recirculated to the contactor kit (3).
2. A stream of fine concentrate that contains the fine material recovered in the process.

### DESCRIPTION OF THE PREFERRED EMBODIMENTS

The present invention relates to functionalized hollow glass microspheres for recovering fine hydrophobic particles, comprising on their surface a Si—O—CₓH_{y} group, where X ranges from 1 to 20, and Y ranges from 3 to 60.

In one embodiment of the invention, the functionalized hollow glass microspheres have a size in the range of 1 to 300 microns.

In another embodiment of the invention, the functionalized hollow glass microspheres have a size similar to the size of the fine material to be recovered.

Additionally, the present invention refers to a method for preparing functionalized hollow glass microspheres, which comprises the following steps:
Providing hollow glass microspheres;
Reacting the hollow glass microspheres with a compound having a hydroxyl group, by the reaction between the silanol group (Si—O—H) on the glass surface and a hydroxyl group (—OH) of a related compound that is applicable to the hydrophobization methodology of the surface of the hollow glass microsphere;
Obtaining the functionalized glass microspheres; and
Storing the microspheres wet or dry.

In one embodiment of the method for preparing functionalized hollow glass microspheres, the related compound corresponds to a primary or secondary organic alcohol.

In a preferred embodiment of the method for preparing functionalized hollow glass microspheres, the primary alcohol is selected from the group consisting of ethanol, butanol, heptanol, octanol, dodecanol, or other primary alcohol.

In an equally preferred embodiment of the method for preparing functionalized hollow glass microspheres, the secondary alcohol is methyl isobutyl carbinol (MIBC).

In another preferred embodiment of the invention of the method for preparing functionalized hollow glass microspheres, the related compound corresponds to a collector having at least one hydroxyl group.

Furthermore, the present invention relates to a system for functionalizing hollow glass microspheres, which comprises:
i. A reactor (1) where the necessary conditions are provided for the functionalization chemical reaction to occur, which includes means for heating and means for stirring that keep the hollow glass microspheres in constant suspension and stirring;
ii. Optionally, a recirculation equipment (2) for vapors generated resulting from boiling within the reactor (1), which allows the recirculation of the organic compound back to the reactor (1); and
iii. Fresh feed means of organic compound.

In an embodiment of the invention in the system for functionalizing the hollow glass microspheres, the means for heating comprise heat exchange means.

In a preferred embodiment of the invention in the system for functionalizing hollow glass microspheres, the heat exchange means are selected from the group consisting of a heating plate, a heating jacket, a heating coil, a tube bundle heated by gases or liquids, radiation means, microwave radiation means, or other applicable technology for heat exchange.

In another embodiment of the invention in the system for functionalizing the hollow glass microspheres, the recirculation equipment (2) that allows to recover the vaporized organic compound resulting from the heating is a condenser that returns the generated vapors to a liquid state.

In a preferred embodiment of the invention in the system to functionalize the hollow glass microspheres, the recirculation equipment (2) that can separate the water generated by the reaction of the organic compound is a distillation column, an absorption tower, or other applicable technology.

In an even more preferred embodiment of the invention in the system for functionalizing the hollow glass microspheres, the recirculation equipment (2) that allows to recover the vaporized organic compound resulting from the heating is a two-phase condenser (aqueous and organic).

In another embodiment of the invention in the system for functionalizing the hollow glass microspheres, in case of not using a recirculation equipment (2), a direct replacement of the evaporated organic compound can be made.

The present invention also relates to a method for selectively recovering fine material, which comprises:
a) Feeding to a contactor equipment (3) the functionalized hollow glass microspheres and the suspension comprising the fine material;
b) Causing the collision between the functionalized hollow glass microspheres with the fine material, to achieve their adhesion;
c) Bringing the stream of functionalized hollow glass microspheres with the adhered fine material to a separation equipment (4);
d) Separating the functionalized hollow glass microspheres with adhered fine material, generating an enriched stream and a discard stream. The latter corresponds to a stream from which all or a large part of the fine material that initially contained the feed to the contactor equipment (3) has been extracted.

In one embodiment of the invention, the method for selectively recovering fine material optionally comprises a step e) for recovering the functionalized hollow glass microspheres through a recovery equipment (5), which allows recycling the functionalized hollow glass microspheres, thus reducing the consumption of functionalized hollow glass microspheres fed to the contactor equipment (3).

In a preferred embodiment of the invention in the method for selectively recovering fine material, the step of separation of the streams that occurs in the separation equipment (4) may be by physical methods or it may require the incorporation of a separation agent.

In one embodiment of the invention in the method for selectively recovering fine material, the fine material corresponds to hydrophobic fine material.

In a preferred embodiment of the invention in the method for selectively recovering fine material, the hydrophobic fine material has a size less than or equal to 20 microns.

In a preferred embodiment of the invention in the method for selectively recovering fine material, the material to be recovered is selected from the group consisting of minerals, microdroplets of organic compounds, plastics, pollutants, among others.

In an even more preferred embodiment of the invention in the method for selectively recovering fine material, the material to be recovered corresponds to a mineral, preferably being a copper ore.

The present invention also relates to the use of functionalized hollow glass microspheres because they are useful for selectively recovering fine material.

In a preferred embodiment of the invention in the use of functionalized hollow glass microspheres, the fine material is hydrophobic.

In an even more preferred embodiment of the invention in the use of functionalized hollow glass microspheres, the hydrophobic fine material has a size less than or equal to 20 microns.

In another embodiment of the invention in the use of functionalized hollow glass microspheres, the material to be recovered is selected from the group consisting of minerals, organic microdroplets, plastics, contaminants, among others, preferably being a mineral, and more preferably a copper ore.

### APPLICATION EXAMPLES

### Example 1

To produce functionalized hollow glass microspheres, 1-butanol was used as the functionalizing reagent. In a stirred reactor, 50 g of glass microspheres and 140 g of analytical grade 1-butanol were added. The reactor was connected to a distillation tower at full reflux and stirring and heating commenced. It was stirred at 200 rpm given the temperature and particle size of the microspheres. The temperature used corresponds to the boiling point of the alcohol (118° C.) and was kept for 7 hours.

The full reflux distillation tower acts as a gas stream purifier as the organic compound is recirculated to the reactor.

Once the reaction was finished, the system was stopped and the solution obtained was extracted from the reactor, which was cooled, washed, and filtered. Washing was carried out with excess acetone and subsequently with ethanol. Then, the functionalized hollow glass microspheres were stored in a container with water.

### Example 2

The functionalized glass microspheres were used to evaluate their impact on the flotation kinetics of fine particles, using a copper ore from an operating plant. The mineral used was mainly composed of bornite and gangue. Bornite is a copper sulfide that can be recovered through the flotation process, while gangue is discarded by tailings. In these tests three cases were evaluated:
1. Flotation baseline without glass microspheres.
2. Flotation assisted by non-functionalized hollow glass microspheres.
3. Flotation assisted by functionalized hollow glass microspheres.

In the first case, fine bornite mineral (15-micron P₈₀) suspended in an aqueous solution was chemically conditioned in the flotation cell prior to injection of air. The mineral was conditioned by means of an appropriate collector and pH to make the bornite surface hydrophobic. On the other hand, the use of a frother makes it possible to avoid the coalescence of bubbles, obtaining a suitable size for the process. This conditioning considered the addition of sodium isopropyl xanthate as a collector, a mixture of polyglycols as a frother, and adjustment of pH to 10.5 using sodium hydroxide.

The second case was carried out in the same way as the first, but additionally considered the incorporation of non-functionalized hollow glass microspheres during the conditioning process.

In the third case, the fine bornite mineral (15-micron P₈₀) suspended in an aqueous solution was fed together with the functionalized hollow glass microspheres of Example 1 to a contactor equipment (3), which corresponded to the same flotation cell (prior to air injection). The mixing of the components in the cell by stirring allows the collision between the functionalized hollow glass microspheres and fine particles. As in the other cases, the mineral was conditioned using an appropriate collector and pH to make the bornite surface hydrophobic. In this way, the bornite particles can adhere to the surface of the functionalized hollow glass microspheres. However, the addition of a frother was not necessary in this case. In fact, the simultaneous use of functionalized hollow glass microspheres and froth generates excessive stability in the froth zone, which ends up destabilizing the system. From the above, it is concluded that the use of functionalized hollow glass microspheres makes it possible to eliminate the use of froth in flotation. Therefore, the conditioning in this third case only consisted of the use of sodium isopropyl xanthate as a collector and adjustment of pH to 10.5 by means of sodium hydroxide.

After conditioning, the bornite was recovered in the separation equipment (4), which corresponded to a mechanical flotation cell for the purposes of this example. In the mechanical flotation cell, aeration and the formation of air bubbles allow the collection of bornite particles and the functionalized hollow glass microspheres with the adhered bornite particles.

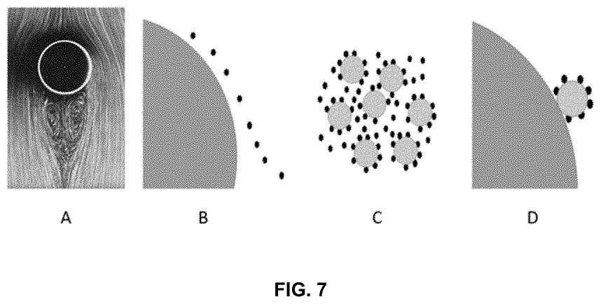

In the third case, the collection and transport to the froth zone of the cell occurs for 2 reasons: First, the functionalized hollow glass microspheres have a density of less than 1, therefore, when suspended in water, they move naturally towards the top of the cell, dragging the fine bornite particles with them. Second, the adhesion of the fine particles to the surface of the functionalized hollow glass microspheres generates a larger aggregate, which eliminates the root cause of inefficiencies in the flotation of very fine particles (see FIG. 7).

Bornite concentrates were generated from the flotation cell for each experiment. The concentrates were collected at minutes 1, 2, 4, 8, and 16. The concentrates were dried in an oven at 105° C. and weighed to obtain the recovered mass. To obtain the copper grade of each concentrate, the acid digestion and atomic absorption methodology was used.

Following the previously described methodology, tests were performed in triplicate and the results of Table 3 were obtained. Using these results, the graph with the floating kinetics curves of FIG. 5 and the graph with the grade-recovery curves of FIG. 6 were prepared.

TABLE 3
Results of recovered mass and concentrate grade
in the experiments carried out in Example 2.

| | | Test 1 | | Test 2 | | Test 3 | |
|---|---|---|---|---|---|---|---|
| | | | Copper | | Copper | | Copper |
| | | Mass | Grade | Mass | Grade | Mass | Grade |
| | | [g] | [%] | [g] | [%] | [g] | [%] |
| Without | Feed | 829.7 | 1.08 | 834.5 | 1.09 | 840.6 | 1.08 |
| microspheres | Concentrate min 1 | 3.9 | 35.94 | 4.3 | 35.53 | 4.0 | 38.17 |
| | Concentrate min 2 | 3.3 | 36.55 | 5.0 | 33.50 | 4.2 | 31.07 |
| | Concentrate min 4 | 3.8 | 29.44 | 4.9 | 27.21 | 5.0 | 26.71 |
| | Concentrate min 8 | 4.3 | 21.32 | 4.6 | 18.88 | 5.1 | 19.36 |
| | Concentrate min 16 | 5.8 | 14.62 | 6.5 | 12.59 | 6.1 | 11.56 |
| | Tailing | 808.6 | 0.36 | 809.2 | 0.30 | 816.2 | 0.29 |
| With non- | Feed | 826 | 1.06 | 832.7 | 1.06 | 831.4 | 1.09 |
| functionalized | Concentrate min 1 | 9.5 | 30.66 | 5.1 | 37.67 | 7.2 | 34.16 |
| microspheres | Concentrate min 2 | 2.4 | 35.74 | 4.3 | 31.88 | 3.4 | 30.81 |
| | Concentrate min 4 | 2.5 | 28.63 | 4.7 | 24.67 | 4.1 | 26.65 |
| | Concentrate min 8 | 4.2 | 20.10 | 6.4 | 17.26 | 5.0 | 18.68 |
| | Concentrate min 16 | 7.3 | 11.07 | 11.2 | 8.33 | 9.1 | 9.70 |
| | Tailing | 800.1 | 0.27 | 801.0 | 0.24 | 802.6 | 0.27 |
| With | Feed | 840.7 | 1.08 | 839.8 | 1.07 | 828.9 | 1.06 |
| functionalized | Concentrate min 1 | 8.2 | 46.02 | 9.6 | 44.27 | 9.7 | 46.70 |
| microspheres | Concentrate min 2 | 5.2 | 41.42 | 5.4 | 34.32 | 4.3 | 34.62 |
| | Concentrate min 4 | 6.7 | 22.94 | 5.7 | 16.04 | 5.4 | 19.70 |
| | Concentrate min 8 | 9.2 | 4.67 | 7.7 | 5.58 | 5.7 | 7.11 |
| | Concentrate min 16 | 11.7 | 1.42 | 8.7 | 1.93 | 8.2 | 2.23 |
| | Tailing | 799.7 | 0.07 | 802.7 | 0.09 | 795.6 | 0.09 |

The experimental evaluation of the adhesion of fine particles with functionalized hollow glass microspheres, which were subsequently collected in a mechanical flotation cell, allowed to effectively recover the fine particles (below 20 microns). In the flotation kinetic tests, when comparing the results of the flotation baseline of fine particles without assistance of glass microspheres with the results of assisted flotation by functionalized hollow glass microsphere, it was possible to increase the kinetic constant by 140% and raise the recovery of valuable mineral from 65% to 90%, showing that particles above and below 20 microns can be effectively collected, see FIG. 5. Additionally, the use of functionalized hollow glass microspheres caused a shift in the grade-recovery curve (see FIG. 6) towards zones of higher metallurgical performance, which is an indication that this invention allows to effectively improve selectivity and recovery of fine particles. The result of FIG. 6 is of great relevance because, by allowing higher grades and higher recoveries simultaneously, the economic performance that can be obtained from a flotation process is increased.

It is worth mentioning that the use of functionalized hollow glass microspheres generated a significant increase in the froth depth and stability during the experiments, which destabilized the flotation system and made its operation not possible. For this reason, it was concluded that the use of functionalized hollow glass microspheres would make it possible to replace the addition of a frother in the flotation process, resulting in a saving of this last chemical reagent.

### CONCLUSIONS

The functionalized hollow glass microsphere is an innovative product that improves the recovery, concentration, and selective separation of particles or fine droplets of hydrophobic materials. This invention can be applied for the recovery of minerals, organic microdroplets, solvents, plastics, bitumen, pollutants, etc.
A system and a method were developed for the functionalization of the hollow glass microsphere, based on the chemical adhesion of organic compounds to its surface. Additionally, a method was designed for the production of functionalized hollow glass microspheres on a laboratory, pilot, and/or industrial scale.
The use of functionalized hollow glass microspheres improves the flotation kinetics of fine minerals. This technology allows to increase the flotation kinetic constant by 140% and, in addition, it allows to increase the maximum recovery of fine material to values of around 90%. This result shows that functionalized hollow glass microspheres can be applied as a solution to the fine particles flotation problem.
The use of hollow and hydrophobicized glass microspheres causes a shift in the grade-recovery curve for the flotation process of fine particles. Therefore, its use allows to increase the economic performance of the process.
In the context of the flotation process, the use of functionalized hollow glass microspheres replaces the use of a frother. That is, adding frother is not required when functionalized hollow glass microspheres are used in a flotation cell.
Functionalized hollow glass microspheres can be used in conventional flotation processes. In other words, no significant modification of the operating conditions of a standard flotation process is required to apply this new technology.

The foregoing specification is provided for illustrative purposes only and is not intended to describe all possible aspects of the present invention. While the invention has been disclosed herein and described in detail with respect to various exemplary embodiments, those skilled in the art will appreciate that minor changes to the description and various other modifications, omissions, and additions are made without departing from the spirit and the scope of the same.

1. Functionalized hollow glass microspheres for recovering fine hydrophobic particles, CHARACTERIZED in that they comprise a Si—O—CₓH_{y} group on their surface, where X ranges from 1 to 20, and Y ranges from 3 to 60.

2. Functionalized hollow glass microspheres according to claim 2, CHARACTERIZED in that they have a size in the range of 1 to 300 microns.

3. Functionalized hollow glass microspheres according to claim 1, CHARACTERIZED in that they have a size similar to the size of the fine material to be recovered.

4. Method for preparing the functionalized hollow glass microspheres according to claim 1, CHARACTERIZED in that it comprises the following steps:
Providing hollow glass microspheres;
Reacting the hollow glass microspheres with a compound having a hydroxyl group, by the reaction between the silanol group (Si—O—H) on the glass surface and a hydroxyl group (—OH) of a related compound that is applicable to the hydrophobization methodology of the surface of the hollow glass microsphere;
Obtaining the functionalized glass microspheres; and
Storing the microspheres wet or dry.

5. Method for preparing the functionalized hollow glass microspheres according to claim 4, CHARACTERIZED in that the related compound corresponds to a primary or secondary organic alcohol.

6. Method for preparing the functionalized hollow glass microspheres according to claim 5, CHARACTERIZED in that the primary alcohol is selected from the group consisting of ethanol, butanol, heptanol, octanol, dodecanol.

7. Method for preparing the functionalized hollow glass microspheres according to claim 5, CHARACTERIZED in that the secondary alcohol is methyl isobutyl carbinol (MIBC).

8. Method for preparing the functionalized hollow glass microspheres according to claim 4, CHARACTERIZED in that the related compound corresponds to a collector having at least one hydroxyl group.

9. System for functionalizing hollow glass microspheres according to the method of claim 4, CHARACTERIZED in that it comprises:
i. A reactor (1) where the necessary conditions are provided for the functionalization chemical reaction to occur, which includes means for heating and means for stirring that keep the hollow glass microspheres in constant suspension and stirring;
ii. Optionally, a recirculation equipment (2) for vapors generated resulting from boiling within the reactor (1), which allows the recirculation of the organic compound back to the reactor (1); and
iii. Fresh feed means of organic compound.

10. System for functionalizing hollow glass microspheres according to claim 9, CHARACTERIZED in that the means for heating comprise heat exchange means.

11. System for functionalizing hollow glass microspheres according to claim 10, CHARACTERIZED in that the heat exchange means are selected from the group consisting of heating plate, heating jacket, heating coil, tube bundle heated by gases or liquids, radiation means, microwave radiation means, or other applicable technology for heat exchange.

12. System for functionalizing hollow glass microspheres according to claim 9, CHARACTERIZED in that the recirculation equipment (2) that makes it possible to recover the vaporized organic compound resulting from the heating is a condenser that returns the generated vapors to a liquid state.

13. System for functionalizing hollow glass microspheres according to claim 9, CHARACTERIZED in that the recirculation equipment (2) that can separate the water generated by the reaction of the organic compound is a distillation column, an absorption tower, or other applicable technology.

14. System for functionalizing hollow glass microspheres according to claim 9, CHARACTERIZED in that the recirculation equipment (2) that recovers the vaporized organic compound resulting from the heating is a two-phase condenser (aqueous and organic).

15. System for functionalizing hollow glass microspheres according to claim 9, CHARACTERIZED in that in case of not using a recirculation equipment (2), a direct replacement of the evaporated organic compound can be made.

16. Method for selectively recovering fine material, CHARACTERIZED in that it comprises:
a) Feeding to a contactor equipment (3) the functionalized hollow glass microspheres and the suspension comprising the fine material;
b) Causing the collision between the functionalized hollow glass microspheres with the fine material, to achieve their adhesion;
c) Bringing the stream of functionalized hollow glass microspheres with adhered fine material to a separation equipment (4);
d) Separating the functionalized hollow glass microspheres with adhered fine material, generating an enriched stream and a discard stream, which corresponds to a stream from which all or a large part of the fine material that initially contained the feed to the contactor equipment (3) has been extracted.

17. Method for selectively recovering fine material according to claim 16, CHARACTERIZED in that it optionally comprises a step e) for recovering the functionalized hollow glass microspheres through a recovery equipment (5), which allows recycling the functionalized hollow glass microspheres, thus reducing the consumption of functionalized hollow glass microspheres fed to the contactor equipment (3).

18. Method for selectively recovering fine material according to claim 16, CHARACTERIZED in that the step of separation of the streams that occurs in the separation equipment (4) may be by physical methods or may require the incorporation of a separation agent.

19. Method for selectively recovering fine material according to claim 16, CHARACTERIZED in that the fine material corresponds to hydrophobic fine material.

20. Method for selectively recovering fine material according to claim 19, CHARACTERIZED in that the hydrophobic fine material has a size less than or equal to 20 microns.

21. Method for selectively recovering fine material according to claim 19, CHARACTERIZED in that the material to be recovered is selected from the group consisting of minerals, microdroplets of organic compounds, plastics, pollutants, among others.

22. Method for selectively recovering fine material according to claim 21, CHARACTERIZED in that the material to be recovered corresponds to a mineral.

23. Method for selectively recovering fine material according to claim 22, CHARACTERIZED in that the mineral corresponds to a copper ore.

24. Use of the functionalized hollow glass microspheres according to claim 1, CHARACTERIZED in that it is useful to selectively recover fine material.

25. Use of the functionalized hollow glass microspheres according to claim 24, CHARACTERIZED in that the fine material is hydrophobic.

26. Use of the functionalized hollow glass microspheres according to claim 24, CHARACTERIZED in that the hydrophobic fine material has a size less than or equal to 20 microns.

27. Use of functionalized hollow glass microspheres according to claim 25, CHARACTERIZED in that the material to be recovered is selected from the group consisting of minerals, microdroplets of organic compounds, plastics, pollutants, among others.

28. Use of the functionalized hollow glass microspheres according to claim 27, CHARACTERIZED in that the material to be recovered corresponds to a mineral.

29. Use of the functionalized hollow glass microspheres according to claim 28, CHARACTERIZED in that the mineral corresponds to a copper ore.
